(19) United States
(12) Patent Application Publication
(10) Pub. No.: US 2020/0259393 A1
(43) Pub. Date: Aug. 13, 2020

(54) ELECTROMAGNETIC MOTOR

(71) Applicant: Vili Brandt, Ljubljana (SI)

(72) Inventors: Vili Brandt, Ljubljana (SI); Miha Jezek, Visnja Gora (SI)

(73) Assignee: Vili Brandt, Ljubljana (SI)

(21) Appl. No.: 16/651,678

(22) PCT Filed: Sep. 27, 2017
(86) PCT No.: PCT/SI2017/000029

§ 371 Date: Mar. 27, 2020

(51) Int. Cl. H02K 7/075; H02K 11/21

(52) U.S. Cl. CPC H02K 7/075; H02K 11/21

(57) ABSTRACT

The object of the invention is an electromagnetic motor, or more specifically a motor that uses a magnet (mp), which is attached to a connecting element (mh), and propels the crankshaft (v) with adequate driving force, serving as a means of propulsion. Such a means of propulsion does not require fossil fuels and presents a decarbonized means of propulsion. The technical problem solved by the invention is such a construction of an electromagnetic motor, which will, with the help of the permanent magnet (mp) that is attached to the connecting element (mh), and an adequate driving force, due to the construction of the freely rotating crankshaft (v), the connecting rod (v1), the permanent magnet (mp), which is attached to the connecting element (mh), the bottom coil (ch) in combination with the top coil (em) and the internal core (j). the sensors (x1), and the controller (y1) that detects and reverses the polarity of both coils (ch, em) in the exact moment before the permanent magnet (mp) reaches its top or bottom equilibrium position, enable the crankshaft (v) propulsion without the addition of fossil fuels or hybrid propulsion.

### OBJECT OF THE INVENTION AND TECHNICAL PROBLEM

The object of invention is an electromagnetic motor, more specifically a motor that uses an arrangement of permanent magnets and an adequate driving force to drive a crankshaft, thus serving as a means of propulsion. This does not require fossil fuels and presents a decarbonized means of propulsion.

The technical problem solved by this invention is such a construction of an electromagnetic motor that would power the crankshaft without the addition of fossil fuels or hybrid propulsion, with the help of permanent magnets and adequate driving force, as a result of the freely rotating crankshaft, connecting rod and piston, and the combination of a coil with an internal core. The term “piston” in this patent application refers to a piston comprised of a magnet and a connecting element, whereby the magnet is firmly fixed on the connecting element. The term “magnet” refers preferably to a natural permanent magnet.

Operation of the electromagnetic motor occurs on several levels. Because the general principals of a classic OTTO piston engine with internal combustion apply, the principle of operation of the electromagnetic motor is based on the rotating crankshaft, whereby the piston is firmly fixed through the connecting rod, which powers the shaft due to the linear movement of the magnet around the coil. In a classic internal combustion engine, the piston is propelled by the force of explosion caused by the combustion of fossil fuels. In the case of an electromagnetic motor, on the other hand, the piston is composed of a magnet and a connecting element, whereby the magnet moves around an internal hollow core of the bottom coil with external windings. An upper coil, with an internal hollow core, statically fixed to the cylinder casing, is attached above the lower coil. Both hollow cores are made from an non-ferromagnetic material. The reversal of polarity in both coils before the top and bottom equilibrium position of the magnet enables the attraction and repulsion of the magnet. The fundamental challenge in regard to the electromagnetic motor is finding the optimal combination of energy input and the rotation of the crankshaft, which requires energy for the reversal of polarity before the equilibrium positions of the magnet, whereby this all together presents the means of propulsion (in different forms of transportation or in industry).

### KNOWN SOLUTIONS

There are very few known designs of electromagnetic motors that utilize the bipolarity of the Earth's electromagnetic field. A well-known design, and the most similar to the solution described in this patent application, is presented by U.S. Pat. No. 8,344,560 B2. According to this document, a magnetically-actuated motor utilizes the stored energy of rare earth magnets and electromagnetic field to drive a moving solenoid assembly (a spool with a special coil of wire wound around an internal core) powered by the magnet up and down. Additionally, a converting mechanism, such as a corresponding shaft and camshaft, transforms the alternating rotation into work, which then undertakes the function of movement. The electromagnetic assembly is thus comprised of a non-ferromagnetic piston with a tube core and a coil with a wire wound around this core. A magnetic actuator thus has a magnet attached to each end of a shaft, whereby a switching mechanism reverses the polarity of the magnets, repelling the electromagnetic assembly from the magnet each time they reach the top and bottom. This is all controlled by a special controller, which assures that the polarity is reversed just in time to repel the magnets. In comparison with the invention presented in this patent application, the mentioned invention utilizes the polarity reversal at the furthest points of the magnetic actuator, whereas the invention presented in this patent application utilizes sensors and a control unit to reverse the polarity of both coils, so that the reversal of polarity location-wise does not occur at the furthest positions, but rather through two coils on the top of the cylinder, in which the polarity is reversed by repelling the magnet from the coils on one side and attracting the magnet towards the coils on the other.

Other known solutions utilize an electromagnetic motor to produce electrical energy and not as means of propulsion, therefore the comparison with similar systems does not lead to the results as described in this patent application.

### TECHNICAL SOLUTION OF THE INVENTION

The presented invention offers a means of propulsion based on the principle of a classic piston engine with the following difference: in a classic engine the pistons are propelled by explosion, whereas in an electromagnetic motor the piston, comprised of a magnet and a connecting element, is propelled by the reversals of electromagnetic polarity in both coils. With the help of the sensors and a control unit the polarity is reversed at the bottom and the top coil, which results in a repulsion and an attraction of the magnet in relation to both coils.

The change from the longitudinal movement of the piston, i.e. a permanent magnet attached by the connecting element to the connecting rod, into the circling motion of the crankshaft, causes discontinuous movement. In the furthest positions, i.e. at the top and the bottom equilibrium positions of the magnet, the operation of the electromagnetic motor is not fluent, with jolts occurring due to transmission. The jolts can be eliminated by connecting individual electromagnetic motors, therefore the connection of more individual electromagnetic motors should be considered as an increase of efficiency in the functioning of the electrical motor resulting in improved transmission.

The invention is illustrated with an embodiment and figures showing the following:

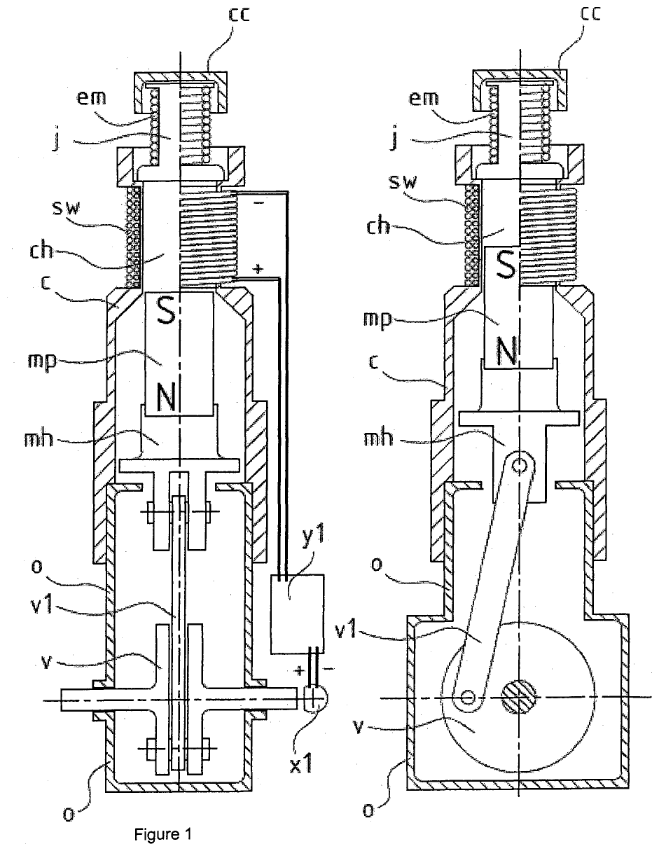

FIG. 1: cross-section view of the electromagnetic motor,

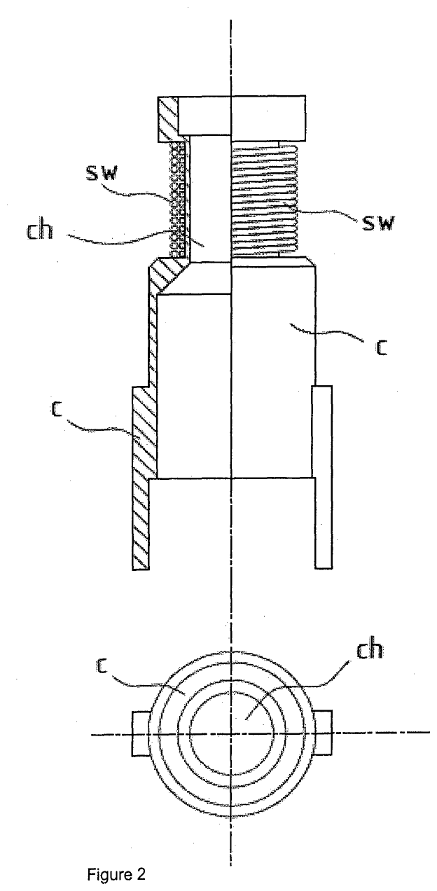

FIG. 2: display of internal construction elements of the coil and the cylinder,

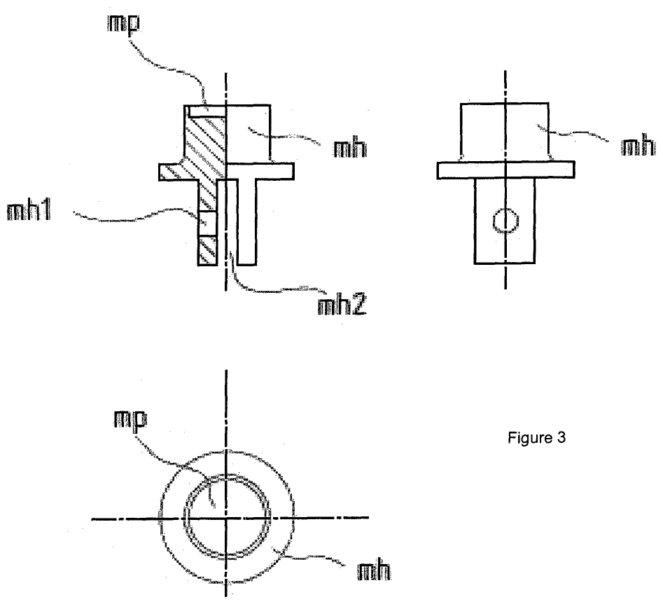

FIG. 3: display of the magnet's fixture to the connecting element,

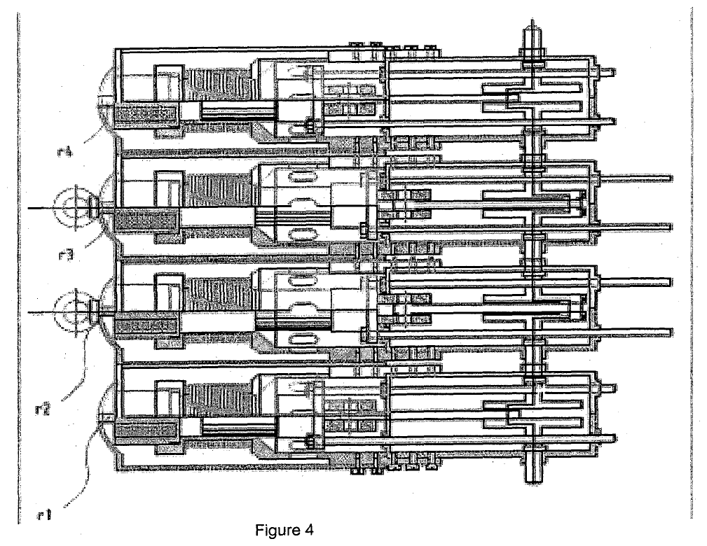

FIG. 4: display of a series of four electromagnetic motors enabling transmission.

The electromagnetic motor depicted in FIG. 1 is composed of a casing (o), in which a freely rotating crankshaft (v) is mounted. The casing of the cylinder (c) is fixedly attached to the casing (o). The bottom coil (ch) with an external winding (sw), which is primarily made of copper wiring wound around a hollow core, is attached to the upper part of the cylinder casing (c). The connecting element (mh) is attached to the connecting rod (v1), which is fixedly attached to the crankshaft (v). The permanent magnet (mp) is fixedly attached using standard methods, primarily with nuts and bolts, to the connecting element (mh). A linear movement of the piston, i.e. the magnet (mp), which is attached to the connecting rod (v1) through the connecting element (mh), is changing into rotational spinning of the shaft (v). The magnet (mp) is thus linearly moving around the hollow core of the bottom coil (ch). The top coil (em) with the internal hollow core (j) is attached to the upper part of the casing of the cylinder (c). The internal core (j) is fixedly attached to the casing of the cylinder (cc) of the top coil (em). All casings and hollow cores are made of non-ferromagnetic materials, primarily plastic.

For the magnet to be able to continuously move around the hollow core of the bottom coil ch, an appropriate reversal of the polarity of both coils is necessary at a precisely determined moment, just before the magnet (mp) reaches its top or bottom equilibrium position. This is enabled with two sensors (x1), which are preferably sensors, and the controller (y1), whereby the sensor (x1) is positioned in a way that it detects the position of the permanent magnet (mp) just before it reaches its top equilibrium position, and the second sensor (x1) is positioned in a way that it detects the position of the magnet (mp) just before it reaches its bottom equilibrium position. Sensors (x1) are attached to the crankshaft (v) and positioned in such a way that they detect the position of the magnet (mp) just before it reaches its top or bottom equilibrium position as an angular displacement of the connecting rod (v1) in relation to the main axis of the freely rotating crankshaft (v), whereby the angular displacement is not less than 3 degrees and not more than 6 degrees beyond of the top or bottom equilibrium positions of the magnet (mp). When the sensors (x1) detect the position of the magnet (mp) just before it reaches its top or bottom equilibrium position, they send an appropriate signal to the control unit (y1), the function of which is to control the sensors (x1) and to prompt the reversal of the polarity of both coils, i.e. the bottom and top coils, (ch) and (em), respectively.

FIG. 2 depicts the internal structure of the bottom coil (ch) with external windings (sw). The right part of the figure shows the casing of the cylinder (c) and the external windings (sw) on the coil. The cross-section shows the plan view of the casing of the cylinder (c) and the plan view of the internal structure of the coil (ch), which is constructed from a hollow core and the external windings (sw) made from a suitable metal.

FIG. 3 depicts one of the ways of attaching the connecting rod to the connecting element (mh). The connecting element (mh) has a formed groove (mh2) with the bores (mh1) for a bolt. The connecting rod is laid into the groove (mh2) and is attached with a bolt. The magnet (mp) is attached to the connecting element (mh) with a screw. This results in the stability of the whole construction of the connector sections, also under extreme pressure conditions.

Described below is a case where the above electromagnetic motor was implemented. The magnet (mp) is attached to the connection element (mh) in such a manner that its north pole (N) is on the side of the attachment and its south pole (S) is on the opposite side. The bottom coil (ch) has the polarity (S) and the top coil (em) has the polarity (N), which results in the attraction of the magnet (mp) with the polarity (N) on the bottom and the polarity (S) on the top. This results in the linear movement of the magnet (mp) around the hollow core of the coil (ch). Because the magnet (mp) is attached to the connecting element (mh), which is in turn attached to the connecting rod (v1), to which the crankshaft (v) is attached, the crankshaft (v) starts to rotate. The sensors (x1) are attached to the crankshaft (v). When the sensor (x1) detects the position of the magnet (mp), just before it reaches its top equilibrium position, i.e. when the angular displacement of the connecting rod (v1) in relation to the main axis of the freely rotating crankshaft (v) is not less than 3 degrees and not more than 6 degrees, it sends an appropriate signal to the controller (y1), which reverses the polarity of both coils. The bottom coil has then the polarity (N) and the top coil has the polarity (S), resulting into the repulsion of the magnet (mp). This results in the linear movement of the magnet (mp) around the hollow core of the coil (ch) in the opposite direction. When the sensor (x1) detects the position of the magnet (mp), just before it reaches its bottom equilibrium position, it sends an appropriate signal to the controller (y1), which again reverses the polarity of both coils. By reversing the polarities of both coils, the linear movement of the magnet (mp) is enabled along the hollow core of the coil (ch) and the cylinder (c) up and down. The opposite implementation is also possible, i.e. that the magnet (mp) has south pole (S) on the side of the attachment and the north pole (N) on the opposite side, whereby the coils' polarities are set accordingly.

FIG. 4 depicts the series connection of four electromagnetic motors to improve the transmission and the uniformity of the rotation of the axis. Therefore, based on the general principle, the reversal of the polarities of coils results in the attraction and repulsion of the magnet, which is connected with the connecting rod through the connecting element and causes the rotation of the crankshaft in proportion to both (bottom and top) equilibrium positions of the magnet through the connecting rod. The starting position of the magnet in the electromagnetic motor is not less than 3 and not more than 6 degrees before the equilibrium position. Due to inertia the magnet moves to the equilibrium position and then the reversal of polarities in both coils causes the magnet to move into the opposite direction. In the first electromagnetic motor (r1) the magnet with the polarity (S)-(N), looking from top down, is not less than 3 and more than 6 degrees ahead of the top equilibrium position, this is why in this phase the polarity in the bottom coil needs to be reversed to the opposite pole (S) and in the top coil to pole (N), in order to cause the magnet to move in the direction of the bottom equilibrium position. In the second electromagnetic motor (r2), the magnet is positioned not less than 3 and not more than 6 degrees ahead of the bottom equilibrium position, this is why in this phase the polarity in the bottom coil needs to be reversed to the opposite pole (S) and in the top coil to pole (N), in order to cause the magnet to return to its original top position. In the course of this the polarity is reversed in both coils, the bottom and the top, because the characteristics of the electromagnetic field enable the creation of the attraction and repulsion only by the opposite distribution of polarity (N-S and S-N) each time. In the third electromagnetic motor (r3), which agrees with the position of the second electromagnetic motor (r2), the same conditions as in the second electromagnetic motor (r2) are present, whereas in the fourth electromagnetic motor (r4), which complies with the position of the first electromagnetic motor (r1), the same conditions as in the first electromagnetic motor (r1) are present. The described transmission enables more efficient surpassing of equilibrium positions, which occur due to the change in linear movement of the piston/the magnet into the rotational spinning of the crankshaft, whereby transmission is not necessary for the sole functioning of the electromagnetic motor, since the engine operates on the one-stroke principle, however, in the case of transmission of four electromagnetic motors, loads can be substantially better overcome due to the change of a linear movement of the magnet into a rotational spinning and resulting in a more uniform rotation of the crankshaft.

1. An electromagnetic motor, which changes the linear movement of the magnet (mp) into rotational spinning of the shaft (v), characterized in that it comprises a casing (o) in which a freely rotating crankshaft (v) is mounted, a casing of the cylinder (c) is fixedly attached to the casing (o), a bottom coil (ch) with the external winding (sw) coiled around its hollow core is fixed to the upper part of the casing of the cylinder (c), a top coil (em) with a hollow internal core (j), which is fixedly attached to a casing of the cylinder (cc) of the top coil (em), is attached to the upper part of the casing of the cylinder (c), a connecting element (mh) to which the magnet (mp) is fixedly attached is attached to a connecting rod (v1), which is fixedly attached to the crankshaft (v), whereby the magnet (mp) moves linearly along the hollow core of the bottom coil (ch) due to the reversal of polarities of the bottom (ch) and the top coil (em), and such reversal of the polarities of the bottom (ch) and the top coil (em) is executed by sensors (x1) and a control unit (y1) just before the magnet (mp) reaches its top or bottom equilibrium position, whereby, when the sensors (x1) detect the position of the magnet (mp) just before it reaches its top or bottom equilibrium position, send an appropriate signal to the control unit (y1), which controls the sensors (x1) and reverses the polarity of both coils, i.e. the bottom coil (ch) and the top coil (em).

2. The electromagnetic motor according to claim 1, characterized in that the connecting element (mh) has a formed slot (mh2) with bores (mh1) for a bolt, whereby the connecting rod (v1) is laid into the slot (mh2) and attached with a bolt, the magnet (mp) is attached to the connecting element (mh) with a screw.

3. The electromagnetic motor according to claim 2, characterized in that one sensor (x1) is positioned in such a way as to detect the position of the magnet (mp) just before it reaches its top equilibrium position and a second sensor (x1) is positioned in such a way as to detect the position of the magnet (mp) just before it reaches its bottom equilibrium position.

4. The electromagnetic motor according to claim 3, characterized in that the two sensors (x1) are attached to the crankshaft (v) and positioned in such a way as to detect the position of the magnet (mp) just before it reaches its final top or bottom equilibrium position as an angular displacement of the connecting rod (v1) in relation to the main axis of the freely rotating crankshaft (v), whereby the angular displacement is not less than 3 degrees and not higher than 6 degrees before the top or the bottom equilibrium position of the magnet (mp).

5. The electromagnetic motor according to claim 1, characterized in that a series connection of four electromagnetic motors leads to improved transmission, whereby in a first (r1) and a fourth (r4) electromagnetic motor the magnet (mp) is positioned just before its top equilibrium position, and in a second (r2) and a third (r3) electromagnetic motor the magnet (mp) is positioned just before its bottom equilibrium position.

6. The electromagnetic motor according to claim 1, characterized in that the magnet (mp) is a natural permanent magnet, whereby the casings and hollow core are made of non-ferromagnetic materials.
